(19) United States
(12) Patent Application Publication
(10) Pub. No.: US 2005/0173203 A1
(43) Pub. Date: Aug. 11, 2005

(54) Brake element having integrated wear sensor

(76) Inventor: Guy Brian Buckner, Brush Creek, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/989,846

(22) Filed: Nov. 16, 2004

Related U.S. Application Data
(60) Provisional application No. 60/481,670, filed on Nov. 19, 2003.

(51) Int. Cl. F16D 65/40

(52) U.S. Cl. 188/1.11 W

(57) ABSTRACT

A brake element for use in applying a frictional braking force to a rotating brake rotor includes a backing plate and a pad of friction material mounted on the backing plate. The backing plate is formed with an integral wear sensor portion in the form of a punched tab feature that is bent out of the mounting plate. A tip end of the wear sensor resides below the level of the outer braking surface of the pad. When the pad wears to the point where the sensor tip is exposed, it rubs on the rotor and generates an audible signal.

This application claims priority to U.S. Provisional Patent Application Ser. No. 60/481,670, filed Nov. 19, 2003.

### BACKGROUND OF THE INVENTION

1. Technical Field

This invention relates generally to brake elements, and more particularly to those used in automotive brake application that are fitted with an audible wear sensor.

2. Related Art

It is known in the art to attach a wear sensor clip or some other necgabucak device to the backing plate of a brake element. When the pad wears, the clip is exposed and rubs on the brake rotor to generate an audible signal which is meant to alert the operator to the worn condition of the brake elements. The separate clips can become lost or dislodged during shipping, installation and/or use and add to the cost and complexity of manufacturing and installing such brake elements.

### SUMMARY OF THE INVENTION

A brake element constructed according to the present invention comprises a backing plate having a front surface on which a pad of friction material is secured. The pad has an outer braking surface that is spaced from the front surface of the backing plate and is adapted to frictionally engage a rotating brake rotor in use. A wear sensor is formed as one piece with the backing plate and projects outwardly of the front surface toward but terminating short of the braking surface of the pad. When the pad wears, the integral sensor is exposed and rubs on the rotating brake rotor to signal a worn condition of the pad.

The invention has the advantage of eliminating parts by incorporating the wear sensor as an integral part of the backing plate.

The one piece construction of the backing plate and wear sensor further simplifies the manufacture of such brake elements since the steps of procuring, stocking, supplying and assembly an otherwise separate wear sensor clip is eliminated.

The one piece wear sensor construction has the further advantage of enabling precise positioning of the wear sensor tip end relative to the front face of the backing plate, and thus the depth of pad wear permitted before the wear sensor is exposed. This has the advantage of getting the most use out of the pads and having consistency from pad to pad.

The structure is much simpler since there is no need to fabricate a clip that has both wear sensor features and mounting features. According to a preferred embodiment, all that may be needed is a punch for displacing a portion of the backing plate out of the plane of the backing plate to yield a tab-like wear sensor projection.

The one-piece construction has the further advantage of offering the manufacturer the flexibility of either forming the wear sensor feature adjacent to the pad (such that it can be formed before or after the pad is secured to the backing plate) or positioned to be embedded or embodied in the friction pad material. This flexibility is not know to be available with the clip-on variety of wear sensors.

### THE DRAWINGS

These and other features and advantages of the present invention will become more readily appreciated when considered in connection with the following detailed description and appended drawings, wherein:

FIG. 1 is a front elevation view of a brake pad made according to a fist embodiment of the invention;

FIG. 2 is an enlarged fragmentary sectional view taken generally along lines 202 of FIG. 1; and

FIG. 3 is a view like FIG. 2, but of an alternative embodiment.

### DETAILED DESCRIPTION

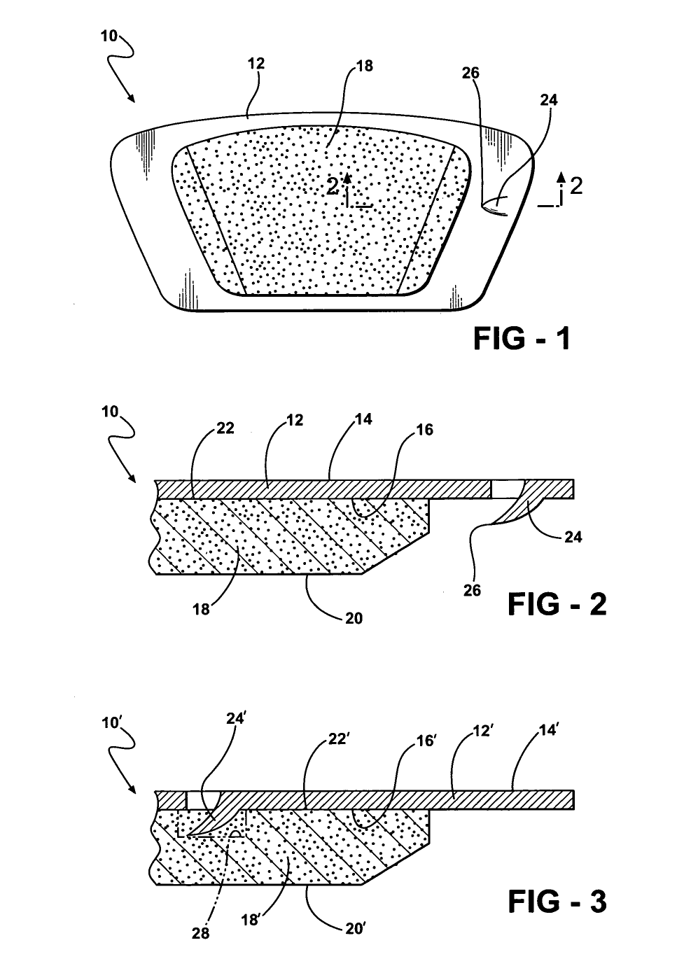

Disclosed in FIGS. 1 and 2 is a brake element 10 constructed according to a first embodiment of the invention having a steel backing plate 12 with a back surface 14 and a front surface 16. A pad 18 of friction material is mounted on the front surface 16. The pad 18 has a predetermined thickness between an outer braking surface 20 and in inner mounting surface 22 or the front surface 16.

The backing plate 12 is formed with an integrated wear sensor 24. The wear sensor 24 projects outwardly from the front surface 16 of the back plate 12 generally towards the outer braking surface 20 of the pad 18. The wear sensor 24 terminates at a tip end 26 spaced between the outer braking surface 20 and the mounting surface 22. According to the first embodiment, the wear sensor 24 is positioned adjacent to rather than embedded in, the friction pad 18. The wear sensor 24 is preferably punched as a tab from the body of the backing plate 12. The tab 24 may be formed prior to or after the friction pad 18 has been mounted on the backing plate 12. As shown best in FIG. 2, the tab 24 remains attached at its base end to the body of the backing plate 12 from which it was formed and thus remains as one piece with the backing plate 12.

The tip end 26 of wear sensor 24 represents a maximum wear condition of the pad 18. In operation, as the friction pad 18 wears through use from braking engagement with a rotating metallic brake rotor (not shown) or the like, the thickness of the friction pad 18 diminishes. Once the pad 18 wears to the point where the braking surface 20 is even (i.e., co-planar) with the tip end 26 of the wear sensor 24, the wear sensor 24 is caused to make the direct rubbing contact with the brake rotor (not shown). This rubbing contact generates an audible signal to the operator of the vehicle that the pad 18 has worn to a condition near to the maximum useful operating life of the brake pad 18, indicating the need for replacement of the brake element 10.

FIG. 3 illustrates an alternative embodiment of the invention, wherein the same reference numerals are used to represent like features with the fist embodiment of FIGS. 1 and 2, but are primed.

Everything with the second embodiment of the brake element 10′ is the same as that of the first embodiment except for the location of the wear sensor 24′. Whereas in the first embodiment the wear sensor 24 was formed adjacent to the brake pad 18, the wear sensor 24′ of the second embodiment is embedded in the friction pad. The embedding can be achieved by forming the wear tab first and then forming the brake pad 18′ on the backing plate 12′ so that the tab 18′ becomes intimately surrounded by and indirect contact with the tab 24′, or the brake pad 18′ can be preformed with a cavity 28 on its inner mounting surface 22′ and positioned to receive the tab 24′ therein when the brake pad 18′ is mounted to the backing plate 12′. With the use of the cavity 28, the wear tab 24′ can be optionally formed in the backing plate 12′ before the pad 18′ is applied.

Obviously, many modifications and variations of the present invention are possible in light of the above teachings. It is, therefore, to be understood that within the scope of the appended claims, the invention may be practiced otherwise than as specifically described.

1. A brake element for frictionally engaging a rotating brake rotor, comprising:
a backing plate having a front surface;
a pad of friction material secured to said front surface of said backing plate, said pad having an outer braking surface spaced from said front surface; and
a wear sensor formed as one piece with the backing plate and projecting outwardly of said front surface generally toward but terminating short of said outer braking surface of said pad and operative when said pad wears to the extent of exposing said wear sensor to rubbing contact with the brake rotor to generate an audible signal indicating a worn condition of said pad.

2. The brake element of claim 1 wherein said wear sensor comprises a tab of material punched from and bent outwardly of said backing plate.

3. The brake element of claim 2 wherein said tab is connected at a base to said backing plate.

4. The brake element of claim 2 wherein said tab is spaced from said pad.

5. The brake element of claim 2 wherein said tab is embedded in said pad.

6. The brake element of claim 2 wherein said backing plate is fabricated of steel.

7. The brake element of claim 1 wherein said wear sensor has a tip end spaced between said outer braking surface of said pad and said front surface of said backing plate.

8. A method of making a brake element for frictionally engaging a rotating metallic brake rotor, said method comprising:
preparing a backing plate having a front surface;
securing a pad of friction material to the front surface of the backing plate, the pad having an outer braking surface spaced from the front surface; and
forming a wear sensor as one piece with the backing plate and projecting the wear sensor outwardly of the front surface and generally toward but terminating short of the outer braking surface of the pad and operative when the pad wears to the extent of exposing the wear sensor to rubbing contact with the brake rotor to generate an audible signal indicating a worn condition of the pad.

9. The method of claim 8 wherein the wear sensor is formed by punching an attached tab of material from the backing plate and bending it outwardly of the front surface of the backing plate.

10. The method of claim 9 wherein the tab is formed in spaced relation to the friction pad.

11. The method of claim 8 wherein the wear sensor is formed to be embedded in the friction pad.
